(19) United States
(12) Patent Application Publication
(10) Pub. No.: US 2024/0178981 A1
(43) Pub. Date: May 30, 2024

(54) TRANSMISSION CONTROL INDICATOR STATE UPDATE FOR MULTIPLE TRANSMIT RECEIVE POINTS

(71) Applicant: QUALCOMM Incorporated, San Diego, CA (US)

(72) Inventors: Ruiming ZHENG, Beijing (CN); Muhammad Sayed Khairy ABDELGHAFFAR, San Jose, CA (US); Yu ZHANG, San Diego, CA (US); Linhai HE, San Diego, CA (US)

(21) Appl. No.: 18/552,597

(22) PCT Filed: May 8, 2021
(86) PCT No.: PCT/CN2021/092339

§ 371 Date: Sep. 26, 2023

(51) Int. Cl. H04L 5/00

(52) U.S. Cl. CPC H04L 5/0094; H04L 5/0035; H04L 5/0053

(57) ABSTRACT

Various aspects of the present disclosure generally relate to wireless communication. In some aspects, a user equipment (UE) may receive a first medium access control control element (MAC-CE) that, alone or with a second MAC-CE, specifies one or more transmission control indicator (TCI) states for a first control resource set (CORESET) identifier (ID) that corresponds to a first transmit receive point (TRP) and one or more TCI states for a second CORESET ID that corresponds to a second TRP. The UE may update spatial relation information for the UE based at least in part on the first MAC-CE. The UE may receive signals from the first or second TRP using the updated spatial relation information. Numerous other aspects are described.

### FIELD OF THE DISCLOSURE

Aspects of the present disclosure generally relate to wireless communication and to techniques and apparatuses for updating transmission control indicator states for multiple transmit receive points.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency-division multiple access (FDMA) systems, orthogonal frequency-division multiple access (OFDMA) systems, single-carrier frequency-division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include a number of base stations (BSs) that can support communication for a number of user equipment (UEs). A UE may communicate with a BS via the downlink and uplink. “Downlink” or “forward link” refers to the communication link from the BS to the UE, and “uplink” or “reverse link” refers to the communication link from the UE to the BS. As will be described in more detail herein, a BS may be referred to as a Node B, a gNB, an access point (AP), a radio head, a transmit receive point (TRP), a New Radio (NR) BS, a 5G Node B, or the like.

The above multiple access technologies have been adopted in various telecommunication standards to provide a common protocol that enables different user equipment to communicate on a municipal, national, regional, and even global level. NR, which may also be referred to as 5G, is a set of enhancements to the LTE mobile standard promulgated by the 3GPP. NR is designed to better support mobile broadband Internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink (DL), using CP-OFDM and/or SC-FDM (e.g., also known as discrete Fourier transform spread OFDM (DFT-s-OFDM)) on the uplink (UL), as well as supporting beamforming, multiple-input multiple-output (MIMO) antenna technology, and carrier aggregation. As the demand for mobile broadband access continues to increase, further improvements in LTE, NR, and other radio access technologies remain useful.

### SUMMARY

In some aspects, a method of wireless communication performed by a user equipment (UE) includes receiving a first medium access control control element (MAC-CE) that, alone or with a second MAC-CE, specifies one or more transmission control indicator (TCI) states for a first control resource set (CORESET) identifier (ID) that corresponds to a first transmit receive point (TRP) and one or more TCI states for a second CORESET ID that corresponds to a second TRP. The method may include updating spatial relation information for the UE based at least in part on the first MAC-CE and receiving signals from the first or second TRP using the updated spatial relation information.

In some aspects, a method of wireless communication performed by a base station includes generating a first MAC-CE that, alone or with a second MAC-CE, specifies one or more TCI states for a first CORESET ID that corresponds to a first TRP and one or more TCI states for a second CORESET ID that corresponds to a second TRP. The method may include transmitting the first MAC-CE.

In some aspects, a UE for wireless communication includes a memory and one or more processors coupled to the memory and configured to receive a first MAC-CE that, alone or with a second MAC-CE, specifies one or more TCI states for a first CORESET ID that corresponds to a first TRP and one or more TCI states for a second CORESET ID that corresponds to a second TRP. The one or more processors may be configured to update spatial relation information for the UE based at least in part on the first MAC-CE and receive signals from the first or second TRP using the updated spatial relation information.

In some aspects, a base station for wireless communication includes a memory and one or more processors coupled to the memory and configured to generate a first MAC-CE that, alone or with a second MAC-CE, specifies one or more TCI states for a first CORESET ID that corresponds to a first TRP and one or more TCI states for a second CORESET ID that corresponds to a second TRP. The one or more processors may be configured to transmit the first MAC-CE.

In some aspects, a non-transitory computer-readable medium storing a set of instructions for wireless communication includes one or more instructions that, when executed by one or more processors of a UE, cause the UE to receive a first MAC-CE that, alone or with a second MAC-CE, specifies one or more TCI states for a first CORESET ID that corresponds to a first TRP and one or more TCI states for a second CORESET ID that corresponds to a second TRP, update spatial relation information for the UE based at least in part on the first MAC-CE, and receive signals from the first or second TRP using the updated spatial relation information.

In some aspects, a non-transitory computer-readable medium storing a set of instructions for wireless communication includes one or more instructions that, when executed by one or more processors of a base station, cause the base station to generate a first MAC-CE that, alone or with a second MAC-CE, specifies one or more TCI states for a first CORESET ID that corresponds to a first TRP and one or more TCI states for a second CORESET ID that corresponds to a second TRP, and transmit the first MAC-CE.

In some aspects, an apparatus for wireless communication includes means for receiving a first MAC-CE that, alone or with a second MAC-CE, specifies one or more TCI states for a first CORESET ID that corresponds to a first TRP and one or more TCI states for a second CORESET ID that corresponds to a second TRP, means for updating spatial relation information for the UE based at least in part on the first MAC-CE, and means for receiving signals from the first or second TRP using the updated spatial relation information.

In some aspects, an apparatus for wireless communication includes means for generating a first MAC-CE that, alone or with a second MAC-CE, specifies one or more TCI states for a first CORESET ID that corresponds to a first TRP and one or more TCI states for a second CORESET ID that corresponds to a second TRP, and means for transmitting the first MAC-CE.

Aspects generally include a method, apparatus, system, computer program product, non-transitory computer-readable medium, user equipment, base station, wireless communication device, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, or artificial intelligence-enabled devices). Aspects may be implemented in chip-level components, modular components, non-modular components, non-chip-level components, device-level components, or system-level components. Devices incorporating described aspects and features may include additional components and features for implementation and practice of claimed and described aspects. For example, transmission and reception of wireless signals may include a number of components for analog and digital purposes (e.g., hardware components including antennas, radio frequency (RF) chains, power amplifiers, modulators, buffers, processor(s), interleavers, adders, or summers). It is intended that aspects described herein may be practiced in a wide variety of devices, components, systems, distributed arrangements, or end-user devices of varying size, shape, and constitution.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a base station in communication with a user equipment (UE) in a wireless network, in accordance with the present disclosure.

FIG. 3 illustrates an example logical architecture of a distributed radio access network, in accordance with the present disclosure.

FIG. 4 is a diagram illustrating an example of multiple transmit receive point communication, in accordance with the present disclosure.

FIG. 5 is a diagram illustrating examples of transmission control indicator (TCI) state indications, in accordance with the present disclosure.

FIG. 6 is a diagram illustrating an example of a TCI indication for multiple control resource sets (CORESETs), in accordance with the present disclosure.

FIG. 7 is a diagram illustrating an example associated with TCI state indications, in accordance with the present disclosure.

FIG. 8 is a diagram illustrating an example process performed, for example, by a UE, in accordance with the present disclosure.

FIG. 9 is a diagram illustrating an example process performed, for example, by a base station, in accordance with the present disclosure.

FIGS. 10-11 are block diagrams of example apparatuses for wireless communication, in accordance with the present disclosure.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. Based on the teachings herein, one skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

It should be noted that while aspects may be described herein using terminology commonly associated with a 5G or NR radio access technology (RAT), aspects of the present disclosure can be applied to other RATs, such as a 3G RAT, a 4G RAT, and/or a RAT subsequent to 5G (e.g., 6G).

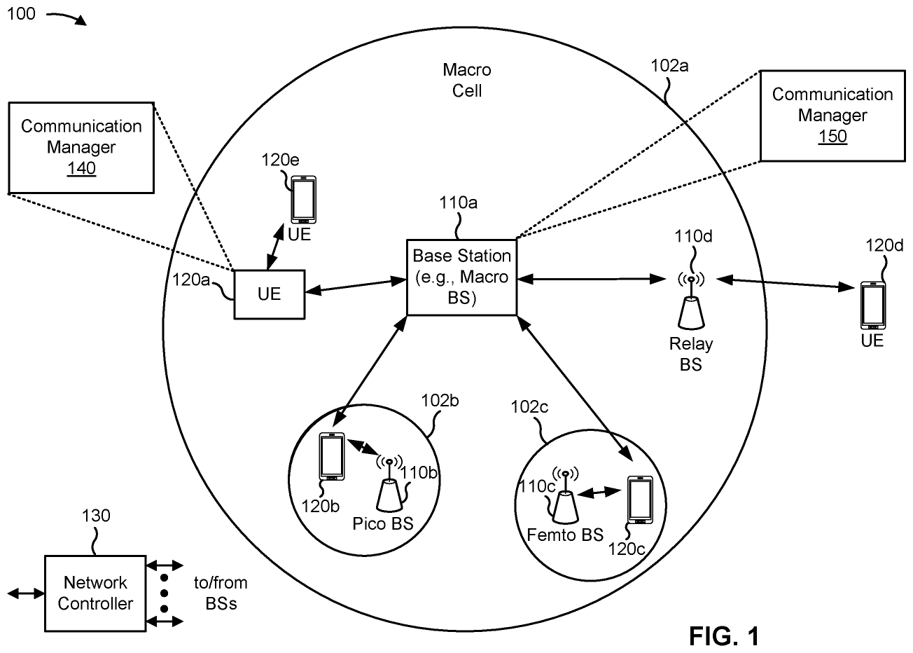

FIG. 1 is a diagram illustrating an example of a wireless network 100, in accordance with the present disclosure. The wireless network 100 may be or may include elements of a 5G (NR) network and/or an LTE network, among other examples. The wireless network 100 may include a number of base stations 110 (shown as BS 110a, BS 110b, BS 110c, and BS 110d) and other network entities. A base station (BS) is an entity that communicates with user equipment (UEs) and may also be referred to as an NR BS, a Node B, a gNB, a 5G node B (NB), an access point, a transmit receive point (TRP), or the like. Each BS may provide communication coverage for a particular geographic area. In 3GPP, the term “cell” can refer to a coverage area of a BS and/or a BS subsystem serving this coverage area, depending on the context in which the term is used.

A BS may provide communication coverage for a macro cell, a pico cell, a femto cell, and/or another type of cell. A macro cell may cover a relatively large geographic area (e.g., several kilometers in radius) and may allow unrestricted access by UEs with service subscription. A pico cell may cover a relatively small geographic area and may allow unrestricted access by UEs with service subscription. A femto cell may cover a relatively small geographic area (e.g., a home) and may allow restricted access by UEs having association with the femto cell (e.g., UEs in a closed subscriber group (CSG)). A BS for a macro cell may be referred to as a macro BS. A BS for a pico cell may be referred to as a pico BS. A BS for a femto cell may be referred to as a femto BS or a home BS. In the example shown in FIG. 1, a BS 110a may be a macro BS for a macro cell 102a, a BS 110b may be a pico BS for a pico cell 102b, and a BS 110c may be a femto BS for a femto cell 102c. A BS may support one or multiple (e.g., three) cells. The terms “eNB”, “base station”, “NR BS”, “gNB”, “TRP”, “AP”, “node B”, “5G NB”, and “cell” may be used interchangeably herein.

In some aspects, a cell may not necessarily be stationary, and the geographic area of the cell may move according to the location of a mobile BS. In some aspects, the BSs may be interconnected to one another and/or to one or more other BSs or network nodes (not shown) in the wireless network 100 through various types of backhaul interfaces, such as a direct physical connection or a virtual network, using any suitable transport network.

Wireless network 100 may also include relay stations. A relay station is an entity that can receive a transmission of data from an upstream station (e.g., a BS or a UE) and send a transmission of the data to a downstream station (e.g., a UE or a BS). A relay station may also be a UE that can relay transmissions for other UEs. In the example shown in FIG. 1, a relay BS 110d may communicate with macro BS 110a and a UE 120d in order to facilitate communication between BS 110a and UE 120d. A relay BS may also be referred to as a relay station, a relay base station, a relay, or the like.

Wireless network 100 may be a heterogeneous network that includes BSs of different types, such as macro BSs, pico BSs, femto BSs, relay BSs, or the like. These different types of BSs may have different transmit power levels, different coverage areas, and different impacts on interference in wireless network 100. For example, macro BSs may have a high transmit power level (e.g., 5 to 40 watts) whereas pico BSs, femto BSs, and relay BSs may have lower transmit power levels (e.g., 0.1 to 2 watts).

A network controller 130 may couple to a set of BSs and may provide coordination and control for these BSs. Network controller 130 may communicate with the BSs via a backhaul. The BSs may also communicate with one another, e.g., directly or indirectly via a wireless or wireline backhaul.

UEs 120 (e.g., 120a, 120b, 120c) may be dispersed throughout wireless network 100, and each UE may be stationary or mobile. A UE may also be referred to as an access terminal, a terminal, a mobile station, a subscriber unit, a station, or the like. A UE may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device or equipment, biometric sensors/devices, wearable devices (smart watches, smart clothing, smart glasses, smart wrist bands, smart jewelry (e.g., smart ring, smart bracelet)), an entertainment device (e.g., a music or video device, or a satellite radio), a vehicular component or sensor, smart meters/sensors, industrial manufacturing equipment, a global positioning system device, or any other suitable device that is configured to communicate via a wireless or wired medium.

Some UEs may be considered machine-type communication (MTC) or evolved or enhanced machine-type communication (eMTC) UEs. MTC and eMTC UEs include, for example, robots, drones, remote devices, sensors, meters, monitors, and/or location tags, that may communicate with a base station, another device (e.g., remote device), or some other entity. A wireless node may provide, for example, connectivity for or to a network (e.g., a wide area network such as Internet or a cellular network) via a wired or wireless communication link. Some UEs may be considered Internet-of-Things (IOT) devices, and/or may be implemented as NB-IOT (narrow band internet of things) devices. Some UEs may be considered a Customer Premises Equipment (CPE). UE 120 may be included inside a housing that houses components of UE 120, such as processor components and/or memory components. In some aspects, the processor components and the memory components may be coupled together. For example, the processor components (e.g., one or more processors) and the memory components (e.g., a memory) may be operatively coupled, communicatively coupled, electronically coupled, and/or electrically coupled.

In general, any number of wireless networks may be deployed in a given geographic area. Each wireless network may support a particular RAT and may operate on one or more frequencies. A RAT may also be referred to as a radio technology, an air interface, or the like. A frequency may also be referred to as a carrier, a frequency channel, or the like. Each frequency may support a single RAT in a given geographic area in order to avoid interference between wireless networks of different RATs. In some cases, NR or 5G RAT networks may be deployed.

In some aspects, two or more UEs 120 (e.g., shown as UE 120a and UE 120e) may communicate directly using one or more sidelink channels (e.g., without using a base station 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol or a vehicle-to-infrastructure (V2I) protocol), and/or a mesh network. In this case, the UE 120 may perform scheduling operations, resource selection operations, and/or other operations described elsewhere herein as being performed by the base station 110.

Devices of wireless network 100 may communicate using the electromagnetic spectrum, which may be subdivided based on frequency or wavelength into various classes, bands, channels, or the like. For example, devices of wireless network 100 may communicate using an operating band having a first frequency range (FR1), which may span from 410 MHz to 7.125 GHZ, and/or may communicate using an operating band having a second frequency range (FR2), which may span from 24.25 GHz to 52.6 GHz. The frequencies between FR1 and FR2 are sometimes referred to as mid-band frequencies. Although a portion of FR1 is greater than 6 GHZ, FR1 is often referred to as a “sub-6 GHz” band. Similarly, FR2 is often referred to as a “millimeter wave” band despite being different from the extremely high frequency (EHF) band (30 GHz-300 GHz) which is identified by the International Telecommunications Union (ITU) as a “millimeter wave” band. Thus, unless specifically stated otherwise, it should be understood that the term “sub-6 GHz” or the like, if used herein, may broadly represent frequencies less than 6 GHz, frequencies within FR1, and/or mid-band frequencies (e.g., greater than 7.125 GHz). Similarly, unless specifically stated otherwise, it should be understood that the term “millimeter wave” or the like, if used herein, may broadly represent frequencies within the EHF band, frequencies within FR2, and/or mid-band frequencies (e.g., less than 24.25 GHZ). It is contemplated that the frequencies included in FR1 and FR2 may be modified, and techniques described herein are applicable to those modified frequency ranges.

In some aspects, the UE 120 may include a communication manager 140. As described in more detail elsewhere herein, the communication manager 140 may receive a first medium access control control element (MAC-CE) that, alone or with a second MAC-CE, specifies one or more transmission control indicator (TCI) states for a first control resource set (CORESET) identifier (ID) that corresponds to a first TRP and one or more TCI states for a second CORESET ID that corresponds to a second TRP. The communication manager 140 may update spatial relation information for the UE based at least in part on the first MAC-CE and receive signals from the first or second TRP using the updated spatial relation information. Additionally, or alternatively, the communication manager 140 may perform one or more other operations described herein.

In some aspects, the base station 110 may include a communication manager 150. As described in more detail elsewhere herein, the communication manager 150 may generate a first MAC-CE that, alone or with a second MAC-CE, specifies one or more TCI states for a first CORESET ID that corresponds to a first TRP and one or more TCI states for a second CORESET ID that corresponds to a second TRP. The communication manager 150 may transmit the first MAC-CE. Additionally, or alternatively, the communication manager 150 may perform one or more other operations described herein.

As indicated above, FIG. 1 is provided as an example. Other examples may differ from what is described with regard to FIG. 1.

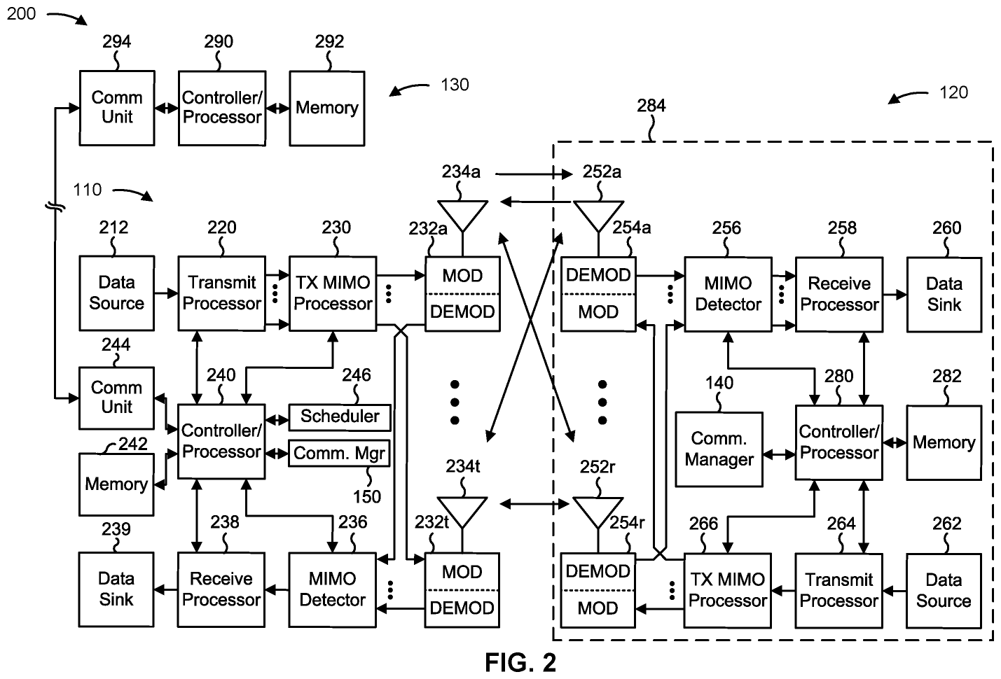

FIG. 2 is a diagram illustrating an example 200 of a base station 110 in communication with a UE 120 in a wireless network 100, in accordance with the present disclosure. Base station 110 may be equipped with T antennas 234a through 234t, and UE 120 may be equipped with R antennas 252a through 252r, where in general T≥1 and R≥1.

At base station 110, a transmit processor 220 may receive data from a data source 212 for one or more UEs, select one or more modulation and coding schemes (MCS) for each UE based at least in part on channel quality indicators (CQIs) received from the UE, process (e.g., encode and modulate) the data for each UE based at least in part on the MCS(s) selected for the UE, and provide data symbols for all UEs. Transmit processor 220 may also process system information (e.g., for semi-static resource partitioning information (SRPI)) and control information (e.g., CQI requests, grants, and/or upper layer signaling) and provide overhead symbols and control symbols. Transmit processor 220 may also generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide T output symbol streams to T modulators (MODs) 232a through 232t. Each modulator 232 may process a respective output symbol stream (e.g., for OFDM) to obtain an output sample stream. Each modulator 232 may further process (e.g., convert to analog, amplify, filter, and upconvert) the output sample stream to obtain a downlink signal. T downlink signals from modulators 232a through 232t may be transmitted via T antennas 234a through 234t, respectively.

At UE 120, antennas 252a through 252r may receive the downlink signals from base station 110 and/or other base stations and may provide received signals to demodulators (DEMODs) 254a through 254r, respectively. Each demodulator 254 may condition (e.g., filter, amplify, downconvert, and digitize) a received signal to obtain input samples. Each demodulator 254 may further process the input samples (e.g., for OFDM) to obtain received symbols. A MIMO detector 256 may obtain received symbols from all R demodulators 254a through 254r, perform MIMO detection on the received symbols if applicable, and provide detected symbols. A receive processor 258 may process (e.g., demodulate and decode) the detected symbols, provide decoded data for UE 120 to a data sink 260, and provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, and/or a CQI parameter, among other examples. In some aspects, one or more components of UE 120 may be included in a housing 284.

Network controller 130 may include communication unit 294, controller/processor 290, and memory 292. Network controller 130 may include, for example, one or more devices in a core network. Network controller 130 may communicate with base station 110 via communication unit 294.

Antennas (e.g., antennas 234a through 234t and/or antennas 252a through 252r) may include, or may be included within, one or more antenna panels, antenna groups, sets of antenna elements, and/or antenna arrays, among other examples. An antenna panel, an antenna group, a set of antenna elements, and/or an antenna array may include one or more antenna elements. An antenna panel, an antenna group, a set of antenna elements, and/or an antenna array may include a set of coplanar antenna elements and/or a set of non-coplanar antenna elements. An antenna panel, an antenna group, a set of antenna elements, and/or an antenna array may include antenna elements within a single housing and/or antenna elements within multiple housings. An antenna panel, an antenna group, a set of antenna elements, and/or an antenna array may include one or more antenna elements coupled to one or more transmission and/or reception components, such as one or more components of FIG. 2.

On the uplink, at UE 120, a transmit processor 264 may receive and process data from a data source 262 and control information (e.g., for reports that include RSRP, RSSI, RSRQ, and/or CQI) from controller/processor 280. Transmit processor 264 may also generate reference symbols for one or more reference signals. The symbols from transmit processor 264 may be precoded by a TX MIMO processor 266 if applicable, further processed by modulators 254a through 254r (e.g., for DFT-s-OFDM or CP-OFDM), and transmitted to base station 110. In some aspects, a modulator and a demodulator (e.g., MOD/DEMOD 254) of the UE 120 may be included in a modem of the UE 120. In some aspects, the UE 120 includes a transceiver. The transceiver may include any combination of antenna(s) 252, modulators and/or demodulators 254, MIMO detector 256, receive processor 258, transmit processor 264, and/or TX MIMO processor 266. The transceiver may be used by a processor (e.g., controller/processor 280) and memory 282 to perform aspects of any of the methods described herein (for example, as described with reference to FIGS. 1-11).

At base station 110, the uplink signals from UE 120 and other UEs may be received by antennas 234, processed by demodulators 232, detected by a MIMO detector 236 if applicable, and further processed by a receive processor 238 to obtain decoded data and control information sent by UE 120. Receive processor 238 may provide the decoded data to a data sink 239 and the decoded control information to controller/processor 240. Base station 110 may include communication unit 244 and communicate to network controller 130 via communication unit 244. Base station 110 may include a scheduler 246 to schedule UEs 120 for downlink and/or uplink communications. In some aspects, a modulator and a demodulator (e.g., MOD/DEMOD 232) of the base station 110 may be included in a modem of the base station 110. In some aspects, the base station 110 includes a transceiver. The transceiver may include any combination of antenna(s) 234, modulators and/or demodulators 232, MIMO detector 236, receive processor 238, transmit processor 220, and/or TX MIMO processor 230. The transceiver may be used by a processor (e.g., controller/processor 240) and memory 242 to perform aspects of any of the methods described herein (for example, as described with reference to FIGS. 1-11).

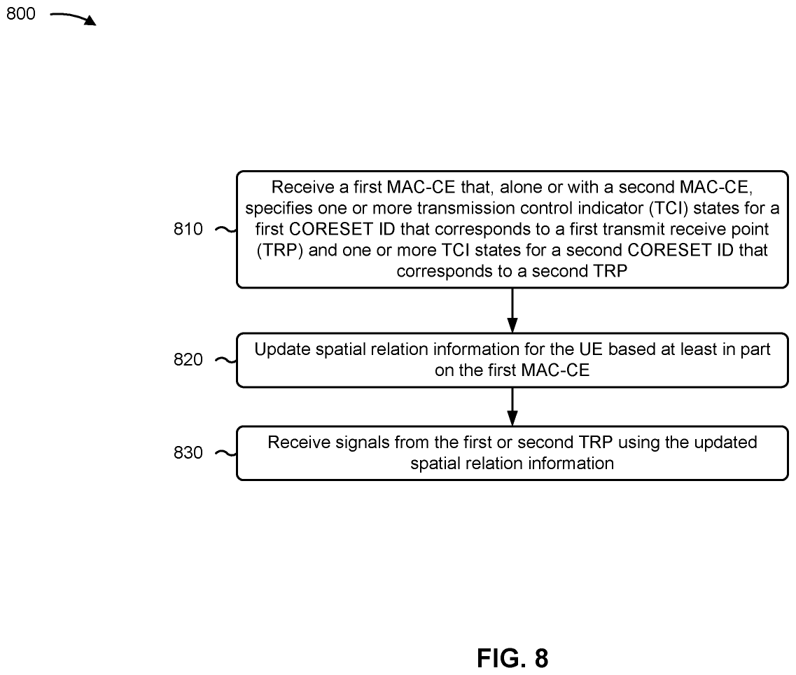

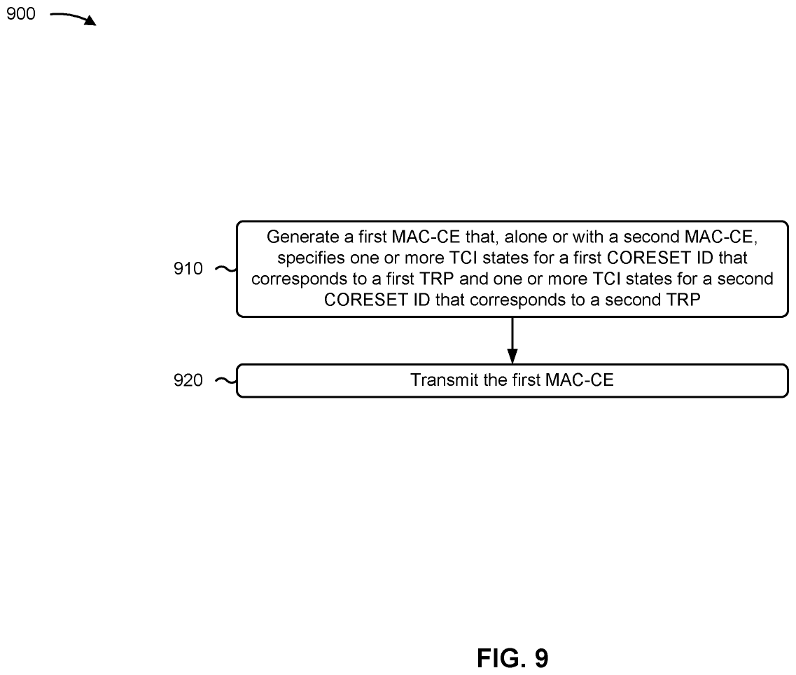

Controller/processor 240 of base station 110, controller/processor 280 of UE 120, and/or any other component(s) of FIG. 2 may perform one or more techniques associated with updating TCI states for multiple TRPs, as described in more detail elsewhere herein. For example, controller/processor 240 of base station 110, controller/processor 280 of UE 120, and/or any other component(s) of FIG. 2 may perform or direct operations of, for example, process 800 of FIG. 8, process 900 of FIG. 9, and/or other processes as described herein. Memories 242 and 282 may store data and program codes for base station 110 and UE 120, respectively. In some aspects, memory 242 and/or memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the base station 110 and/or the UE 120, may cause the one or more processors, the UE 120, and/or the base station 110 to perform or direct operations of, for example, process 800 of FIG. 8, process 900 of FIG. 9, and/or other processes as described herein. In some aspects, executing instructions may include running the instructions, converting the instructions, compiling the instructions, and/or interpreting the instructions, among other examples.

In some aspects, the UE 120 includes means for receiving a first MAC-CE that, alone or with a second MAC-CE, specifies one or more TCI states for a first CORESET ID that corresponds to a first TRP and one or more TCI states for a second CORESET ID that corresponds to a second TRP, means for updating spatial relation information for the UE based at least in part on the first MAC-CE, and/or means for receiving signals from the first or second TRP using the updated spatial relation information. The means for the UE 120 to perform operations described herein may include, for example, one or more of communication manager 140, antenna 252, demodulator 254, MIMO detector 256, receive processor 258, transmit processor 264, TX MIMO processor 266, modulator 254, controller/processor 280, or memory 282.

In some aspects, the base station 110 includes means for generating a first MAC-CE that, alone or with a second MAC-CE, specifies one or more TCI states for a first CORESET ID that corresponds to a first TRP and one or more TCI states for a second CORESET ID that corresponds to a second TRP, and/or means for transmitting the first MAC-CE. The means for the base station 110 to perform operations described herein may include, for example, one or more of communication manager 150, transmit processor 220, TX MIMO processor 230, modulator 232, antenna 234, demodulator 232, MIMO detector 236, receive processor 238, controller/processor 240, memory 242, or scheduler 246.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of controller/processor 280.

As indicated above, FIG. 2 is provided as an example. Other examples may differ from what is described with regard to FIG. 2.

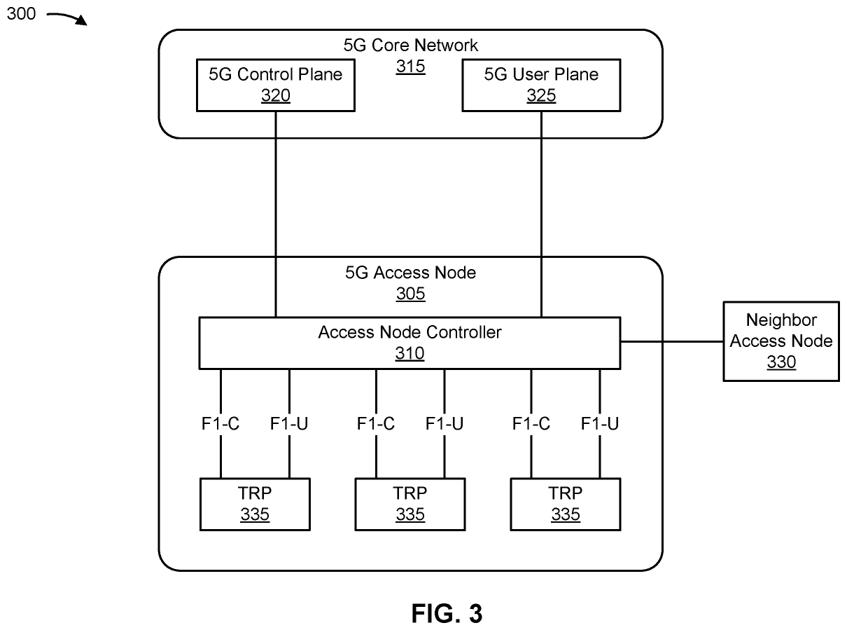

FIG. 3 illustrates an example logical architecture of a distributed radio access network (RAN) 300, in accordance with the present disclosure.

A 5G access node 305 may include an access node controller 310. The access node controller 310 may be a central unit (CU) of the distributed RAN 300. In some aspects, a backhaul interface to a 5G core network 315 may terminate at the access node controller 310. The 5G core network 315 may include a 5G control plane component 320 and a 5G user plane component 325 (e.g., a 5G gateway), and the backhaul interface for one or both of the 5G control plane and the 5G user plane may terminate at the access node controller 310. Additionally, or alternatively, a backhaul interface to one or more neighbor access nodes 330 (e.g., another 5G access node 305 and/or an LTE access node) may terminate at the access node controller 310.

The access node controller 310 may include and/or may communicate with one or more TRPs 335 (e.g., via an F1 Control (F1-C) interface and/or an F1 User (F1-U) interface). A TRP 335 may be a distributed unit (DU) of the distributed RAN 300. In some aspects, a TRP 335 may correspond to a base station 110 described above in connection with FIG. 1. For example, different TRPs 335 may be included in different base stations 110. Additionally, or alternatively, multiple TRPs 335 may be included in a single base station 110. In some aspects, a base station 110 may include a CU (e.g., access node controller 310) and/or one or more DUs (e.g., one or more TRPs 335). In some cases, a TRP 335 may be referred to as a cell, a panel, an antenna array, or an array.

A TRP 335 may be connected to a single access node controller 310 or to multiple access node controllers 310. In some aspects, a dynamic configuration of split logical functions may be present within the architecture of distributed RAN 300. For example, a packet data convergence protocol (PDCP) layer, a radio link control (RLC) layer, and/or a medium access control (MAC) layer may be configured to terminate at the access node controller 310 or at a TRP 335.

In some aspects, multiple TRPs 335 may transmit communications (e.g., the same communication or different communications) in the same transmission time interval (TTI) (e.g., a slot, a mini-slot, a subframe, or a symbol) or different TTIs using different quasi-co-location (QCL) relationships (e.g., different spatial parameters, different TCI states, different precoding parameters, and/or different beamforming parameters). In some aspects, a TCI state may be used to indicate one or more QCL relationships. A TRP 335 may be configured to individually (e.g., using dynamic selection) or jointly (e.g., using joint transmission with one or more other TRPs 335) serve traffic to a UE 120.

As indicated above, FIG. 3 is provided as an example. Other examples may differ from what was described with regard to FIG. 3.

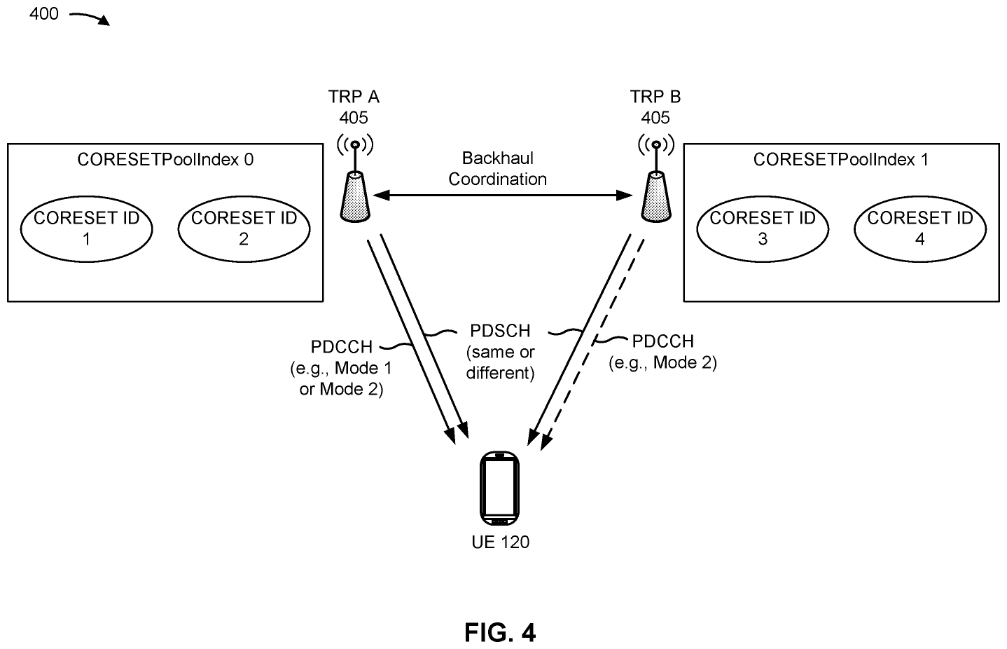

FIG. 4 is a diagram illustrating an example 400 of multi-TRP communication (sometimes referred to as multi-panel communication), in accordance with the present disclosure. As shown in FIG. 4, multiple TRPs 405 may communicate with the same UE 120. A TRP 405 may correspond to a TRP 335 described above in connection with FIG. 3.

The multiple TRPs 405 (shown as TRP A and TRP B) may communicate with the same UE 120 in a coordinated manner (e.g., using coordinated multipoint transmissions) to improve reliability and/or increase throughput. The TRPs 405 may coordinate such communications via an interface between the TRPs 405 (e.g., a backhaul interface and/or an access node controller 310). The interface may have a smaller delay and/or higher capacity when the TRPs 405 are co-located at the same base station 110 (e.g., when the TRPs 405 are different antenna arrays or panels of the same base station 110), and may have a larger delay and/or lower capacity (as compared to co-location) when the TRPs 405 are located at different base stations 110. The different TRPs 405 may communicate with the UE 120 using different QCL relationships (e.g., different TCI states), different DMRS ports, and/or different layers (e.g., of a multi-layer communication).

In a first multi-TRP transmission mode (e.g., Mode 1), a single physical downlink control channel (PDCCH) may be used to schedule downlink data communications for a single physical downlink shared channel (PDSCH). This may also be referred to as a “single downlink control information (sDCI)”_mode or “single-DCI”. When a single-DCI is used to schedule a multi-TCI state transmission, a field in the DCI may indicate at least two TCI states for the purpose of receiving the scheduled PDSCH communication.

In this case, multiple TRPs 405 (e.g., TRP A and TRP B) may transmit communications to the UE 120 on the same PDSCH. For example, a communication may be transmitted using a single codeword with different spatial layers for different TRPs 405 (e.g., where one codeword maps to a first set of layers transmitted by a first TRP 405 and maps to a second set of layers transmitted by a second TRP 405). As another example, a communication may be transmitted using multiple codewords, where different codewords are transmitted by different TRPs 405 (e.g., using different sets of layers). In either case, different TRPs 405 may use different QCL relationships (e.g., different TCI states) for different DMRS ports corresponding to different layers. For example, a first TRP 405 may use a first QCL relationship or a first TCI state for a first set of DMRS ports corresponding to a first set of layers, and a second TRP 405 may use a second (different) QCL relationship or a second (different) TCI state for a second (different) set of DMRS ports corresponding to a second (different) set of layers. In some aspects, a TCI state in DCI (e.g., transmitted on the PDCCH, such as DCI format 1_0 or DCI format 1_1) may indicate the first QCL relationship (e.g., by indicating a first TCI state) and the second QCL relationship (e.g., by indicating a second TCI state). The first and the second TCI states may be indicated using a TCI field in the DCI. In general, the TCI field can indicate a single TCI state (for single-TRP transmission) or multiple TCI states (for multi-TRP transmission as discussed here) in this multi-TRP transmission mode (e.g., Mode 1).

In a second multi-TRP transmission mode (e.g., Mode 2), multiple PDCCHs may be used to schedule downlink data communications for multiple corresponding PDSCHs (e.g., one PDCCH for each PDSCH). This may be referred to as a “multiple DCI (mDCI)” mode or “multi-DCI” from a UE's perspective. In this case, a first PDCCH may schedule a first codeword to be transmitted by a first TRP 405, and a second PDCCH may schedule a second codeword to be transmitted by a second TRP 405. Furthermore, first DCI (e.g., transmitted by the first TRP 405) may schedule a first PDSCH communication associated with a first set of DMRS ports with a first QCL relationship (e.g., indicated by a first TCI state) for the first TRP 405, and second DCI (e.g., transmitted by the second TRP 405) may schedule a second PDSCH communication associated with a second set of DMRS ports with a second QCL relationship (e.g., indicated by a second TCI state) for the second TRP 405. In this case, DCI (e.g., having DCI format 1_0 or DCI format 1_1) may indicate a corresponding TCI state for a TRP 405 corresponding to the DCI. The TCI field of a DCI indicates the corresponding TCI state (e.g., the TCI field of the first DCI indicates the first TCI state and the TCI field of the second DCI indicates the second TCI state). In multi-DCI, a carrier aggregation (CA) framework may be leveraged to treat different TRPs as different virtual component carriers from UE capability perspective.

FIG. 4 also illustrates TRP differentiation at a UE based at least in part on a CORESET pool index, in accordance with the present disclosure. In some aspects, a CORESET pool index (or CORESETPoolIndex) value may be used by a UE (a UE 120) to identify a TRP associated with a grant received on a PDCCH.

A CORESET may refer to a control region that is structured to support an efficient use of resources, such as by flexible configuration or reconfiguration of resources for one or more PDCCHs associated with a UE. In some aspects, a CORESET may occupy the first symbol of an orthogonal frequency division multiplexing (OFDM) slot, the first two symbols of an OFDM slot, or the first three symbols of an OFDM slot. Thus, a CORESET may include multiple resource blocks (RBs) in the frequency domain, and either one, two, or three symbols in the time domain. In 5G, a quantity of resources included in a CORESET may be flexibly configured, such as by using radio resource control (RRC) signaling to indicate a frequency domain region (for example, a quantity of resource blocks) or a time domain region (for example, a quantity of symbols) for the CORESET.

As illustrated in FIG. 4, a UE 120 may be configured with multiple CORESETs in a given serving cell. Each CORESET configured for the UE 120 may be associated with a CORESET ID. For example, a first CORESET configured for the UE 120 may be associated with CORESET ID 1, a second CORESET configured for the UE 120 may be associated with CORESET ID 2, a third CORESET configured for the UE 120 may be associated with CORESET ID 3, and a fourth CORESET configured for the UE 120 may be associated with CORESET ID 4.

As further illustrated in FIG. 4, two or more (for example, up to five) CORESETs may be grouped into a CORESET pool. Each CORESET pool may be associated with a CORESET pool index. As an example, CORESET ID 1 and CORESET ID 2 may be grouped into CORESET pool index 0, and CORESET ID 3 and CORESET ID 4 may be grouped into CORESET pool index 1. In a multi-TRP configuration, each CORESET pool index value may be associated with a particular TRP 405. As an example, and as illustrated in FIG. 4, a first TRP 405 (TRP A) may be associated with CORESET pool index 0 and a second TRP 405 (TRP B) may be associated with CORESET pool index 1. The UE 120 may be configured by a higher layer parameter, such as PDCCH-Config, with information identifying an association between a TRP and a CORESET pool index value assigned to the TRP. Accordingly, the UE may identify the TRP that transmitted a DCI downlink grant by determining the CORESET ID of the CORESET in which the PDCCH carrying the DCI downlink grant was transmitted, determining the CORESET pool index value associated with the CORESET pool in which the CORESET ID is included, and identifying the TRP associated with the CORESET pool index value. The network may transmit a TCI state indication to update a TCI state for a CORESET.

As indicated above, FIG. 4 is provided as an example. Other examples may differ from what is described with respect to FIG. 4.

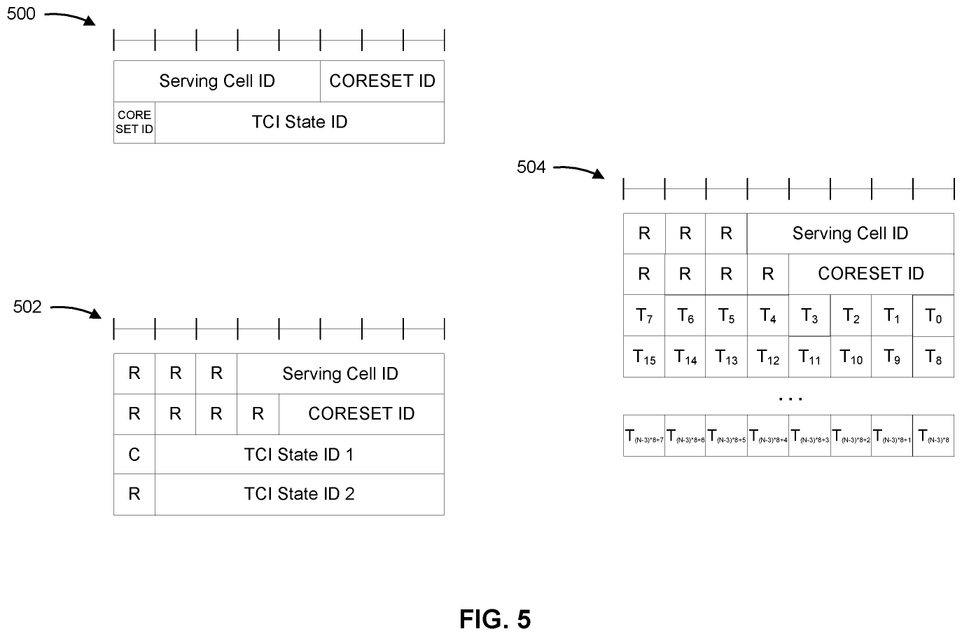

FIG. 5 is a diagram illustrating examples 500, 502 and 504 of TCI state indications, in accordance with the present disclosure.

The network may indicate a TCI state for PDCCH reception for a CORESET of a serving cell or a set of serving cells. The indication may be configured by simultaneousTCI-UpdateList1 or simultaneousTCI-UpdateList2. The indication may be UE-specific and may be sent via a PDCCH MAC-CE. Example 500 shows a MAC-CE (Release 15) that may update one CORESET with one TCI state. The CORESET is identified by a CORESET ID, and the TCI state is identified by a TCI state ID. The indication may include a serving cell ID and may be used to update the CORESET in other serving cells.

In some scenarios, such as a high-speed train single frequency network (HST-SFN) scenario, there may be multiple TCI states that will be activated for a PDCCH communication. A single port DMRS on the PDCCH may be associated with two QCL reference signals that are associated with two TCI states. Example 502 shows a MAC-CE (Release 17) that may be used to update or activate TCI states, among configured TCI states, for a PDCCH communication. The MAC-CE of example 502 includes two TCI states for a single CORESET. The “C” bit may indicate whether the second TCI state ID is to be updated or activated. Example 504 shows another MAC-CE (Release 17) that may update multiple TCI states for a CORESET via a bitmap.

While the MAC-CEs in examples 500, 502, and 504 indicate multiple TCI states for a single CORESET, these MAC-CEs are not sufficient for a multi-DCI, multi-TRP scenario. In single-DCI multi-TRP or single TRP scenarios, a CORESET pool index is not configured for any CORESET ID. In a multi-DCI, multi-TRP scenario, a CORESET may be configured with a CORESET pool index for each TRP. The MAC-CEs of examples 500, 502, and 504 are not sufficient to update TCI states for multiple CORESETs without other signaling overhead that consumes signaling resources.

As indicated above, FIG. 5 provides some examples. Other examples may differ from what is described with regard to FIG. 5.

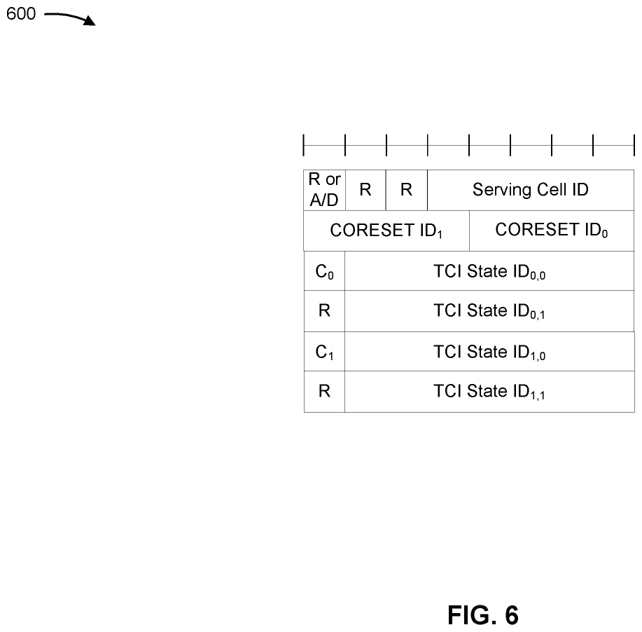

FIG. 6 is a diagram illustrating an example 600 of a TCI indication for multiple CORESETs, in accordance with the present disclosure.

According to various aspects described herein, a base station may update multiple TCI states for at least two CORESETs with a single MAC-CE. A first CORESET may correspond to a first TRP and a second CORESET may correspond to a second TRP. The base station may transmit the MAC-CE to a UE that is operating in a multi-TRP multi-DCI scenario. The first CORESET may correspond to a first DCI, and the second CORESET may correspond to a second DCI. The first CORESET may be part of a first CORESET pool index, and the second CORESET may be part of a second CORESET pool index. The scenario may involve carrier aggregation (CA).

Example 600 shows a MAC-CE that may be transmitted to the UE. The MAC-CE may include a serving cell ID, a first CORESET ID to identify the first.

CORESET, and a second CORESET ID to identify the second CORESET. The MAC-CE may update one TCI state, two TCI states, or more than two TCI states per CORESET ID. For example, “TCI State ID_{0.0}” and “TCI State ID_{0.1}” may be used to update a first TCI state and/or a second TCI state for the first CORESET and “TCI State ID_{1.0}” and “TCI State ID_{1.1}” may be used to update a first TCI state and/or a second TCI state for the second CORESET. An indicator bit “C₀” may indicate whether the octet of “TCI State ID_{0.1}” is to be updated or activated, or is present, and an indicator bit “C₁” may indicate whether the octet of “TCI State ID_{1.1}” is to be updated or activated, or is present. While up to four TCI states may be updated with the MAC-CE in example 600, other MAC-CEs may update more than two TCI states per CORESET or update more than two CORESETs. By using a single MAC-CE, alone, to update CORESETs in a multi-DCI, multi-TRP scenario, the base station and the UE may conserve signaling resources.

In some aspects, the MAC-CE may include an activation bit (shown as “A/D”). The activation bit may be used to activate TCI states that are indicated in the MAC-CE for the two CORESET IDs. For example, if the activation bit is “1”, the indicated TCI states for each CORESET may be activated. The activation bit may also be used to deactivate TCI states that are indicated in the MAC-CE for the two CORESET IDs. For example, if the activation bit is “0”, the indicated TCI states for each CORESET may be deactivated. Reserve bits in the MAC-CE are indicated as “R”.

In some aspects, the serving cell ID may indicate a serving cell that is in a serving cell list with other serving cells. The serving cell list may be preconfigured via RRC signaling. Multi-DCI, multi-TRP may be configured for each serving cell in the serving cell list. The MAC-CE may be used to update TCI states of CORESETs in other serving cells that are included in the list with the serving cell. In this way, multiple CORESETs for multiple serving cells may be updated with a single MAC-CE.

Alternatively, in some scenarios, a UE may not be configured to use a MAC-CE such as shown in example 600. In some aspects, the base station may transmit a first MAC-CE (e.g., example 500 MAC-CE, example 502 MAC-CE, example 504 MAC-CE) that updates a first CORESET for a first TRP in a multi-DCI, multi-TRP arrangement. The base station may then transmit a second MAC-CE (e.g., example 500 MAC-CE, example 502 MAC-CE, example 504 MAC-CE) that updates a second CORESET for a second TRP in the same multi-DCI, multi-TRP arrangement. The CORESETs may be from different CORESET pool indices. In this way, TCI states for both CORESETs of both TRPs may be updated in a consistent manner if the MAC-CE of example 600 is not available.

As indicated above, FIG. 6 is provided as an example. Other examples may differ from what is described with regard to FIG. 6.

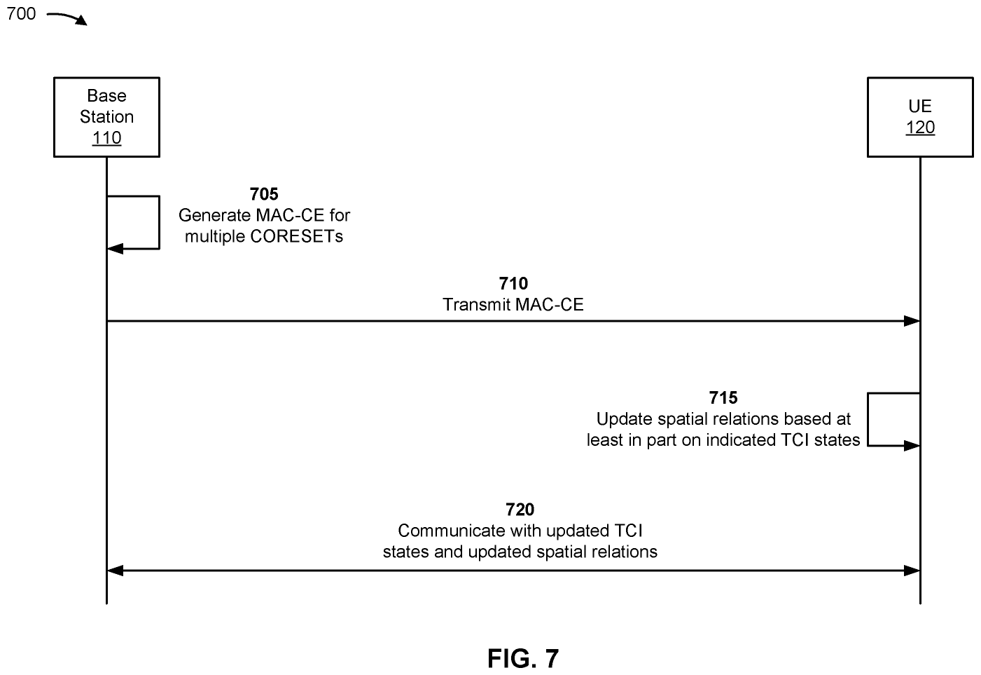

FIG. 7 is a diagram illustrating an example 700 associated with TCI state indications, in accordance with the present disclosure. As shown in FIG. 7, a base station 110 and a UE 120 may communicate with one another.

As shown by reference number 705, the base station 110 may generate a MAC-CE that will update one or more TCI states for two CORESETs. The MAC-CE may be the MAC-CE shown by example 600. As shown by reference number 710, the base station 110 may transmit the MAC-CE.

The UE 120 may receive the MAC-CE. As shown by reference number 715, the UE 120 may update spatial relation information (e.g., a beam configuration) for the UE 120 based at least in part on the updated TCI states indicated for the two CORESETs in the MAC-CE. For example, a TCI state may be associated with a transmit beam of a beam pair, and a spatial relation may be associated with a receive beam of the beam pair. A spatial relation may be based at least in part on a QCL relationship associated with the TCI state. The UE 120 may determine a spatial relation for each TCI state that is indicated based at least in part on configured beam pairs or other beam configuration information.

In some aspects, the UE 120 may determine which PDCCH mode is to be used for a CORESET pool index, without additional signaling. For example, if two TCI states are updated for CORESETs, the PDCCH mode is a single frequency network (SFN) mode. If only one TCI state is updated for CORESETs, the PDCCH mode is a non-SFN mode.

As shown by reference number 720, the base station 110 and the UE 120 may communicate using the updated TCI states and the updated spatial relations. For example, the base station 110 may transmit reference signals using the updated TCI states, and the UE 120 may receive the reference signals using the updated spatial relations. In this way, the beams in a multi-DCI, multi-TRP arrangement may be aligned between the base station 110 and the UE 120 with a single MAC-CE and without other signaling.

As indicated above, FIG. 7 is provided as an example. Other examples may differ from what is described with respect to FIG. 7.

FIG. 8 is a diagram illustrating an example process 800 performed, for example, by a UE, in accordance with the present disclosure. Example process 800 is an example where the UE (e.g., UE 120) performs operations associated with updating TCI states for multiple TRPs.

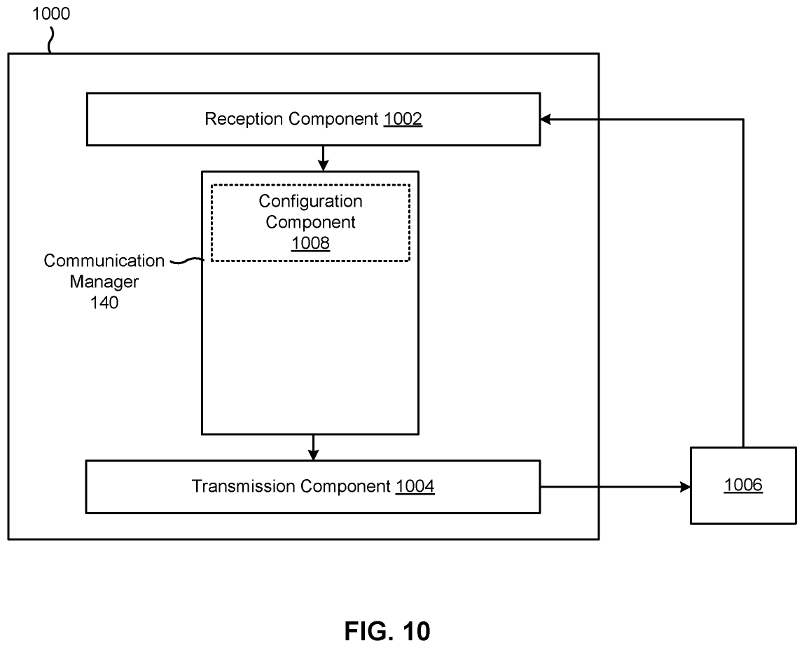

As shown in FIG. 8, in some aspects, process 800 may include receiving a first MAC-CE that, alone or with a second MAC-CE, specifies one or more TCI states for a first CORESET ID that corresponds to a first TRP and one or more TCI states for a second CORESET ID that corresponds to a second TRP (block 810). For example, the UE (e.g., using communication manager 140 and/or reception component 1002 depicted in FIG. 10) may receive a first MAC-CE that, alone or with a second MAC-CE, specifies one or more TCI states for a first CORESET ID that corresponds to a first TRP and one or more TCI states for a second CORESET ID that corresponds to a second TRP, as described above.

As further shown in FIG. 8, in some aspects, process 800 may include updating spatial relation information for the UE based at least in part on the first MAC-CE (block 820). For example, the UE (e.g., using communication manager 140 and/or configuration component 1008 depicted in FIG. 10) may update spatial relation information for the UE based at least in part on the first MAC-CE, as described above.

As further shown in FIG. 8, in some aspects, process 800 may include receiving signals from the first or second TRP using the updated spatial relation information (block 830). For example, the UE (e.g., using communication manager 140 and/or reception component 1002 depicted in FIG. 10) may receive signals from the first or second TRP using the updated spatial relation information, as described above.

Process 800 may include additional aspects, such as any single aspect or any combination of aspects described below and/or in connection with one or more other processes described elsewhere herein.

In a first aspect, the first MAC-CE alone specifies the one or more TCI states for the first CORESET ID and the one or more TCI states for the second CORESET ID.

In a second aspect, alone or in combination with the first aspect, the first MAC-CE specifies at least two TCI states for the first CORESET ID.

In a third aspect, alone or in combination with one or more of the first and second aspects, the first MAC-CE specifies at least two TCI states for the second CORESET ID.

In a fourth aspect, alone or in combination with one or more of the first through third aspects, the first MAC-CE includes an indicator bit that specifies whether a second TCI state of the one or more TCI states for the first CORESET ID is to be updated.

In a fifth aspect, alone or in combination with one or more of the first through fourth aspects, first MAC-CE includes an activation bit that specifies whether to activate or deactivate the one or more TCI states for the first CORESET ID and the one or more TCI states for the second CORESET ID.

In a sixth aspect, alone or in combination with one or more of the first through fifth aspects, the first CORESET ID is part of a first CORESET pool index associated with the first TRP, and the second CORESET ID is part of a second CORESET pool index associated with the second TRP.

In a seventh aspect, alone or in combination with one or more of the first through sixth aspects, the one or more TCI states for the first CORESET ID correspond to a first DCI and the one or more TCI states for the second CORESET ID correspond to a second DCI.

In an eighth aspect, alone or in combination with one or more of the first through seventh aspects, the first MAC-CE indicates a serving cell, and process 800 includes updating TCI states for CORESET IDs of other serving cells that are included in a serving cell list with the serving cell, based at least in part on TCI states for CORESET IDs that are indicated in the first MAC-CE.

In a ninth aspect, alone or in combination with one or more of the first through eighth aspects, the first MAC-CE indicates an SFN PDCCH mode if the first MAC-CE specifies at least two TCI states for each CORESET ID.

In a tenth aspect, alone or in combination with one or more of the first through ninth aspects, the first MAC-CE indicates a non-SFN PDCCH mode if the first MAC-CE specifies only one TCI state for each CORESET ID.

In an eleventh aspect, alone or in combination with one or more of the first through tenth aspects, the first MAC-CE specifies the one or more TCI states for the first CORESET ID, and process 800 includes receiving the second MAC-CE, and wherein the second MAC-CE specifies the one or more TCI states for the second CORESET ID.

Although FIG. 8 shows example blocks of process 800, in some aspects, process 800 may include additional blocks, fewer blocks, different blocks, or differently arranged blocks than those depicted in FIG. 8. Additionally, or alternatively, two or more of the blocks of process 800 may be performed in parallel.

FIG. 9 is a diagram illustrating an example process 900 performed, for example, by a base station, in accordance with the present disclosure. Example process 900 is an example where the base station (e.g., base station 110) performs operations associated with updating TCI states for multiple TRPs.

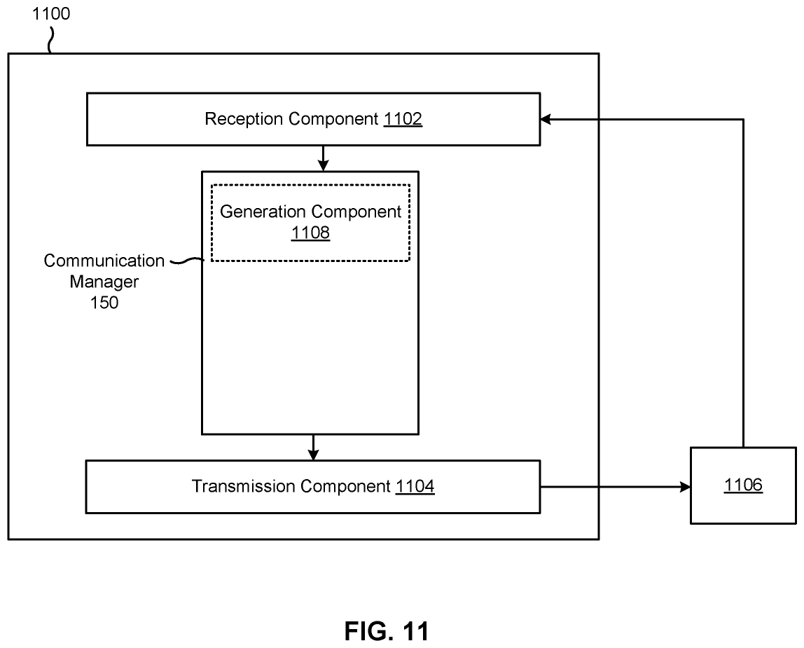

As shown in FIG. 9, in some aspects, process 900 may include generating a first MAC-CE that, alone or with a second MAC-CE, specifies one or more TCI states for a first CORESET ID that corresponds to a first TRP and one or more TCI states for a second CORESET ID that corresponds to a second TRP (block 910). For example, the base station (e.g., using communication manager 150 and/or generation component 1108 depicted in FIG. 11) may generate a first MAC-CE that, alone or with a second MAC-CE, specifies one or more TCI states for a first CORESET ID that corresponds to a first TRP and one or more TCI states for a second CORESET ID that corresponds to a second TRP, as described above.

As further shown in FIG. 9, in some aspects, process 900 may include transmitting the first MAC-CE (block 920). For example, the base station (e.g., using communication manager 150 and/or transmission component 1104 depicted in FIG. 11) may transmit the first MAC-CE, as described above.

Process 900 may include additional aspects, such as any single aspect or any combination of aspects described below and/or in connection with one or more other processes described elsewhere herein.

In a first aspect, the first MAC-CE alone specifies the one or more TCI states for the first CORESET ID and the one or more TCI states for the second CORESET ID.

In a second aspect, alone or in combination with the first aspect, the first MAC-CE specifies at least two TCI states for the first CORESET ID.

In a third aspect, alone or in combination with one or more of the first and second aspects, the first MAC-CE specifies at least two TCI states for the second CORESET ID.

In a fourth aspect, alone or in combination with one or more of the first through third aspects, the first MAC-CE includes an indicator bit that specifies whether a second TCI state of the one or more TCI states for the first CORESET ID is to be updated.

In a fifth aspect, alone or in combination with one or more of the first through fourth aspects, first MAC-CE includes an activation bit that specifies whether to activate or deactivate the one or more TCI states for the first CORESET ID and the one or more TCI states for the second CORESET ID.

In a sixth aspect, alone or in combination with one or more of the first through fifth aspects, the first CORESET ID is part of a first CORESET pool index associated with the first TRP, and the second CORESET ID is part of a second CORESET pool index associated with the second TRP.

In a seventh aspect, alone or in combination with one or more of the first through sixth aspects, the one or more TCI states for the first CORESET ID correspond to a first DCI and the one or more TCI states for the second CORESET ID correspond to a second DCI.

In an eighth aspect, alone or in combination with one or more of the first through seventh aspects, the first MAC-CE indicates a serving cell that is used to update TCI states for CORESET IDs of other serving cells that are included in a serving cell list with the serving cell, based at least in part on TCI states for CORESET IDs that are indicated in the first MAC-CE.

In a ninth aspect, alone or in combination with one or more of the first through eighth aspects, the first MAC-CE indicates an SFN PDCCH mode if the first MAC-CE specifies at least two TCI states for each CORESET ID.

In a tenth aspect, alone or in combination with one or more of the first through ninth aspects, the first MAC-CE indicates a non-SFN PDCCH mode if the first MAC-CE specifies only one TCI state for each CORESET ID.

In an eleventh aspect, alone or in combination with one or more of the first through tenth aspects, the first MAC-CE specifies the one or more TCI states for the first CORESET ID, and process 900 includes transmitting the second MAC-CE, wherein the second MAC-CE specifies the one or more TCI states for the second CORESET ID.

Although FIG. 9 shows example blocks of process 900, in some aspects, process 900 may include additional blocks, fewer blocks, different blocks, or differently arranged blocks than those depicted in FIG. 9. Additionally, or alternatively, two or more of the blocks of process 900 may be performed in parallel.

FIG. 10 is a block diagram of an example apparatus 1000 for wireless communication. The apparatus 1000 may be a UE, or a UE may include the apparatus 1000. In some aspects, the apparatus 1000 includes a reception component 1002 and a transmission component 1004, which may be in communication with one another (for example, via one or more buses and/or one or more other components). As shown, the apparatus 1000 may communicate with another apparatus 1006 (such as a UE, a base station, or another wireless communication device) using the reception component 1002 and the transmission component 1004. As further shown, the apparatus 1000 may include the communication manager 140. The communication manager 140 may include a configuration component 1008, among other examples.

In some aspects, the apparatus 1000 may be configured to perform one or more operations described herein in connection with FIGS. 1-7. Additionally, or alternatively, the apparatus 1000 may be configured to perform one or more processes described herein, such as process 800 of FIG. 8. In some aspects, the apparatus 1000 and/or one or more components shown in FIG. 10 may include one or more components of the UE described above in connection with FIG. 2. Additionally, or alternatively, one or more components shown in FIG. 10 may be implemented within one or more components described above in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1002 may receive communications, such as reference signals, control information, data communications, or a combination thereof, from the apparatus 1006. The reception component 1002 may provide received communications to one or more other components of the apparatus 1000. In some aspects, the reception component 1002 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1006. In some aspects, the reception component 1002 may include one or more antennas, a demodulator, a MIMO detector, a receive processor, a controller/processor, a memory, or a combination thereof, of the UE described above in connection with FIG. 2.

The transmission component 1004 may transmit communications, such as reference signals, control information, data communications, or a combination thereof, to the apparatus 1006. In some aspects, one or more other components of the apparatus 1006 may generate communications and may provide the generated communications to the transmission component 1004 for transmission to the apparatus 1006. In some aspects, the transmission component 1004 may perform signal processing on the generated communications (such as filtering, amplification, modulation, digital-to-analog conversion, multiplexing, interleaving, mapping, or encoding, among other examples), and may transmit the processed signals to the apparatus 1006. In some aspects, the transmission component 1004 may include one or more antennas, a modulator, a transmit MIMO processor, a transmit processor, a controller/processor, a memory, or a combination thereof, of the UE described above in connection with FIG. 2. In some aspects, the transmission component 1004 may be co-located with the reception component 1002 in a transceiver.

The reception component 1002 may receive a first MAC-CE that, alone or with a second MAC-CE, specifies one or more TCI states for a first CORESET ID that corresponds to a first TRP and one or more TCI states for a second CORESET ID that corresponds to a second TRP. The configuration component 1008 may update spatial relation information for the UE based at least in part on the first MAC-CE. The reception component 1002 may receive signals from the first or second TRP using the updated spatial relation information.

The number and arrangement of components shown in FIG. 10 are provided as an example. In practice, there may be additional components, fewer components, different components, or differently arranged components than those shown in FIG. 10. Furthermore, two or more components shown in FIG. 10 may be implemented within a single component, or a single component shown in FIG. 10 may be implemented as multiple, distributed components. Additionally, or alternatively, a set of (one or more) components shown in FIG. 10 may perform one or more functions described as being performed by another set of components shown in FIG. 10.

FIG. 11 is a block diagram of an example apparatus 1100 for wireless communication. The apparatus 1100 may be a base station, or a base station may include the apparatus 1100. In some aspects, the apparatus 1100 includes a reception component 1102 and a transmission component 1104, which may be in communication with one another (for example, via one or more buses and/or one or more other components). As shown, the apparatus 1100 may communicate with another apparatus 1106 (such as a UE, a base station, or another wireless communication device) using the reception component 1102 and the transmission component 1104. As further shown, the apparatus 1100 may include the communication manager 150. The communication manager 150 may include a generation component 1108, among other examples.

In some aspects, the apparatus 1100 may be configured to perform one or more operations described herein in connection with FIGS. 1-7. Additionally, or alternatively, the apparatus 1100 may be configured to perform one or more processes described herein, such as process 900 of FIG. 9. In some aspects, the apparatus 1100 and/or one or more components shown in FIG. 11 may include one or more components of the base station described above in connection with FIG. 2. Additionally, or alternatively, one or more components shown in FIG. 11 may be implemented within one or more components described above in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1102 may receive communications, such as reference signals, control information, data communications, or a combination thereof, from the apparatus 1106. The reception component 1102 may provide received communications to one or more other components of the apparatus 1100. In some aspects, the reception component 1102 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1106. In some aspects, the reception component 1102 may include one or more antennas, a demodulator, a MIMO detector, a receive processor, a controller/processor, a memory, or a combination thereof, of the base station described above in connection with FIG. 2.

The transmission component 1104 may transmit communications, such as reference signals, control information, data communications, or a combination thereof, to the apparatus 1106. In some aspects, one or more other components of the apparatus 1106 may generate communications and may provide the generated communications to the transmission component 1104 for transmission to the apparatus 1106. In some aspects, the transmission component 1104 may perform signal processing on the generated communications (such as filtering, amplification, modulation, digital-to-analog conversion, multiplexing, interleaving, mapping, or encoding, among other examples), and may transmit the processed signals to the apparatus 1106. In some aspects, the transmission component 1104 may include one or more antennas, a modulator, a transmit MIMO processor, a transmit processor, a controller/processor, a memory, or a combination thereof, of the base station described above in connection with FIG. 2. In some aspects, the transmission component 1104 may be co-located with the reception component 1102 in a transceiver.

The generation component 1108 may generate a first MAC-CE that, alone or with a second MAC-CE, specifies one or more TCI states for a first CORESET ID that corresponds to a first TRP and one or more TCI states for a second CORESET ID that corresponds to a second TRP. The transmission component 1104 may transmit the first MAC-CE.

The number and arrangement of components shown in FIG. 11 are provided as an example. In practice, there may be additional components, fewer components, different components, or differently arranged components than those shown in FIG. 11. Furthermore, two or more components shown in FIG. 11 may be implemented within a single component, or a single component shown in FIG. 11 may be implemented as multiple, distributed components. Additionally, or alternatively, a set of (one or more) components shown in FIG. 11 may perform one or more functions described as being performed by another set of components shown in FIG. 11.

The following provides an overview of some Aspects of the present disclosure:

Aspect 1: A method of wireless communication performed by a user equipment (UE), comprising: receiving a first medium access control control element (MAC-CE) that, alone or with a second MAC-CE, specifies one or more transmission control indicator (TCI) states for a first control resource set (CORESET) identifier (ID) that corresponds to a first transmit receive point (TRP) and one or more TCI states for a second CORESET ID that corresponds to a second TRP: updating spatial relation information for the UE based at least in part on the first MAC-CE: and receiving signals from the first or second TRP using the updated spatial relation information.

Aspect 2: The method of Aspect 1, wherein the first MAC-CE alone specifies the one or more TCI states for the first CORESET ID and the one or more TCI states for the second CORESET ID.

Aspect 3: The method of Aspect 2, wherein the first MAC-CE specifies at least two TCI states for the first CORESET ID.

Aspect 4: The method of Aspect 3, wherein the first MAC-CE specifies at least two TCI states for the second CORESET ID.

Aspect 5: The method of any of Aspects 2-4, wherein the first MAC-CE includes an indicator bit that specifies whether a second TCI state of the one or more TCI states for the first CORESET ID is to be updated.

Aspect 6: The method of any of Aspects 2-5, wherein first MAC-CE includes an activation bit that specifies whether to activate or deactivate the one or more TCI states for the first CORESET ID and the one or more TCI states for the second CORESET ID.

Aspect 7: The method of any of Aspects 1-6, wherein the first CORESET ID is part of a first CORESET pool index associated with the first TRP, and the second CORESET ID is part of a second CORESET pool index associated with the second TRP.

Aspect 8: The method of any of Aspects 1-7, wherein the one or more TCI states for the first CORESET ID correspond to a first downlink control information (DCI) and the one or more TCI states for the second CORESET ID correspond to a second DCI.

Aspect 9: The method of any of Aspects 1-8, wherein the first MAC-CE indicates a serving cell, and wherein the method further comprises updating TCI states for CORESET IDs of other serving cells that are included in a serving cell list with the serving cell, based at least in part on TCI states for CORESET IDs that are indicated in the first MAC-CE.

Aspect 10: The method of any of Aspects 1-9, wherein the first MAC-CE indicates a single frequency network physical downlink control channel mode if the first MAC-CE specifies at least two TCI states for each CORESET ID.

Aspect 11: The method of any of Aspects 1-9, wherein the first MAC-CE indicates a non-single frequency network physical downlink control channel mode if the first MAC-CE specifies only one TCI state for each CORESET ID.

Aspect 12: The method of any of Aspects 1 and 7-11, wherein the first MAC-CE specifies the one or more TCI states for the first CORESET ID, wherein the method further comprises receiving the second MAC-CE, and wherein the second MAC-CE specifies the one or more TCI states for the second CORESET ID.

Aspect 13: A method of wireless communication performed by a base station, comprising: generating a first medium access control control element (MAC-CE) that, alone or with a second MAC-CE, specifies one or more transmission control indicator (TCI) states for a first control resource set (CORESET) identifier (ID) that corresponds to a first transmit receive point (TRP) and one or more TCI states for a second CORESET ID that corresponds to a second TRP: and transmitting the first MAC-CE.

Aspect 14: The method of Aspect 13, wherein the first MAC-CE alone specifies the one or more TCI states for the first CORESET ID and the one or more TCI states for the second CORESET ID.

Aspect 15: The method of Aspect 14, wherein the first MAC-CE specifies at least two TCI states for the first CORESET ID.

Aspect 16: The method of Aspect 15, wherein the first MAC-CE specifies at least two TCI states for the second CORESET ID.

Aspect 17: The method of any of Aspects 14-16, wherein the first MAC-CE includes an indicator bit that specifies whether a second TCI state of the one or more TCI states for the first CORESET ID is to be updated.

Aspect 18: The method of any of Aspects 14-17, wherein first MAC-CE includes an activation bit that specifies whether to activate or deactivate the one or more TCI states for the first CORESET ID and the one or more TCI states for the second CORESET ID.

Aspect 19: The method of any of Aspects 13-18, wherein the first CORESET ID is part of a first CORESET pool index associated with the first TRP, and the second CORESET ID is part of a second CORESET pool index associated with the second TRP.

Aspect 20: The method of any of Aspects 13-19, wherein the one or more TCI states for the first CORESET ID correspond to a first downlink control information (DCI) and the one or more TCI states for the second CORESET ID correspond to a second DCI.

Aspect 21: The method of any of Aspects 13-20, wherein the first MAC-CE indicates a serving cell that is used to update TCI states for CORESET IDs of other serving cells that are included in a serving cell list with the serving cell, based at least in part on TCI states for CORESET IDs that are indicated in the first MAC-CE.

Aspect 22: The method of any of Aspects 13-20, wherein the first MAC-CE indicates a single frequency network physical downlink control channel mode if the first MAC-CE specifies at least two TCI states for each CORESET ID.

Aspect 23: The method of any of Aspects 13-20, wherein the first MAC-CE indicates a non-single frequency network physical downlink control channel mode if the first MAC-CE specifies only one TCI state for each CORESET ID.

Aspect 24: The method of any of Aspects 13 and 17-23, wherein the first MAC-CE specifies the one or more TCI states for the first CORESET ID, and wherein the method further comprises transmitting the second MAC-CE, wherein the second MAC-CE specifies the one or more TCI states for the second CORESET ID.

Aspect 25: An apparatus for wireless communication at a device, comprising a processor: memory coupled with the processor: and instructions stored in the memory and executable by the processor to cause the apparatus to perform the method of one or more of Aspects 1-24.

Aspect 26: A device for wireless communication, comprising a memory and one or more processors coupled to the memory, the one or more processors configured to perform the method of one or more of Aspects 1-24.

Aspect 27: An apparatus for wireless communication, comprising at least one means for performing the method of one or more of Aspects 1-24.

Aspect 28: A non-transitory computer-readable medium storing code for wireless communication, the code comprising instructions executable by a processor to perform the method of one or more Aspects of Aspects 1-24.

Aspect 29: A non-transitory computer-readable medium storing a set of instructions for wireless communication, the set of instructions comprising one or more instructions that, when executed by one or more processors of a device, cause the device to perform the method of one or more Aspects of Aspects 1-24.

The foregoing disclosure provides illustration and description, but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a processor is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods were described herein without reference to specific software code—it being understood that software and hardware can be designed to implement the systems and/or methods based, at least in part, on the description herein.

As used herein, satisfying a threshold may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. In fact, many of these features may be combined in ways not specifically recited in the claims and/or disclosed in the specification. Although each dependent claim listed below may directly depend on only one claim, the disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

1. A method of wireless communication performed by a user equipment (UE), comprising:
receiving a first medium access control control element (MAC-CE) that, alone or with a second MAC-CE, specifies one or more transmission control indicator (TCI) states for a first control resource set (CORESET) identifier (ID) that corresponds to a first transmit receive point (TRP) and one or more TCI states for a second CORESET ID that corresponds to a second TRP;
updating spatial relation information for the UE based at least in part on the first MAC-CE; and
receiving signals from the first or second TRP using the updated spatial relation information.

2. The method of claim 1, wherein the first MAC-CE alone specifies the one or more TCI states for the first CORESET ID and the one or more TCI states for the second CORESET ID.

3. The method of claim 2, wherein the first MAC-CE specifies at least two TCI states for the first CORESET ID.

4. The method of claim 3, wherein the first MAC-CE specifies at least two TCI states for the second CORESET ID.

5.-12. (canceled)

13. A method of wireless communication performed by a base station, comprising:
generating a first medium access control control element (MAC-CE) that, alone or with a second MAC-CE, specifies one or more transmission control indicator (TCI) states for a first control resource set (CORESET) identifier (ID) that corresponds to a first transmit receive point (TRP) and one or more TCI states for a second CORESET ID that corresponds to a second TRP; and
transmitting the first MAC-CE.

14. The method of claim 13, wherein the first MAC-CE alone specifies the one or more TCI states for the first CORESET ID and the one or more TCI states for the second CORESET ID.

15.-24. (canceled)

25. A user equipment (UE) for wireless communication, comprising:
a memory; and
one or more processors, coupled to the memory, configured to:
receive a first medium access control control element (MAC-CE) that, alone or with a second MAC-CE, specifies one or more transmission control indicator (TCI) states for a first control resource set (CORESET) identifier (ID) that corresponds to a first transmit receive point (TRP) and one or more TCI states for a second CORESET ID that corresponds to a second TRP;
update spatial relation information for the UE based at least in part on the first MAC-CE; and
receive signals from the first or second TRP using the updated spatial relation information.

26. The UE of claim 25, wherein the first MAC-CE alone specifies the one or more TCI states for the first CORESET ID and the one or more TCI states for the second CORESET ID.

27. The UE of claim 26, wherein the first MAC-CE specifies at least two TCI states for the first CORESET ID.

28. The UE of claim 27, wherein the first MAC-CE specifies at least two TCI states for the second CORESET ID.

29. The UE of claim 26, wherein the first MAC-CE includes an indicator bit that specifies whether a second TCI state of the one or more TCI states for the first CORESET ID is to be updated.

30. The UE of claim 26, wherein first MAC-CE includes an activation bit that specifies whether to activate or deactivate the one or more TCI states for the first CORESET ID and the one or more TCI states for the second CORESET ID.

31. The UE of claim 25, wherein the first CORESET ID is part of a first CORESET pool index associated with the first TRP, and the second CORESET ID is part of a second CORESET pool index associated with the second TRP.

32. The UE of claim 25, wherein the one or more TCI states for the first CORESET ID correspond to a first downlink control information (DCI) and the one or more TCI states for the second CORESET ID correspond to a second DCI.

33. The UE of claim 25, wherein the first MAC-CE indicates a serving cell, and wherein the one or more processors are configured to update TCI states for CORESET IDs of other serving cells that are included in a serving cell list with the serving cell, based at least in part on TCI states for CORESET IDs that are indicated in the first MAC-CE.

34. The UE of claim 25, wherein the first MAC-CE indicates a single frequency network physical downlink control channel mode if the first MAC-CE specifies at least two TCI states for each CORESET ID.

35. The UE of claim 25, wherein the first MAC-CE indicates a non-single frequency network physical downlink control channel mode if the first MAC-CE specifies only one TCI state for each CORESET ID.

36. The UE of claim 25, wherein the first MAC-CE specifies the one or more TCI states for the first CORESET ID, wherein the one or more processors are configured to receive the second MAC-CE, and wherein the second MAC-CE specifies the one or more TCI states for the second CORESET ID.

37. A base station for wireless communication, comprising:
a memory; and
one or more processors, coupled to the memory, configured to:
generate a first medium access control control element (MAC-CE) that, alone or with a second MAC-CE, specifies one or more transmission control indicator (TCI) states for a first control resource set (CORESET) identifier (ID) that corresponds to a first transmit receive point (TRP) and one or more TCI states for a second CORESET ID that corresponds to a second TRP; and
transmit the first MAC-CE.

38. The base station of claim 37, wherein the first MAC-CE alone specifies the one or more TCI states for the first CORESET ID and the one or more TCI states for the second CORESET ID.

39. The base station of claim 38, wherein the first MAC-CE specifies at least two TCI states for the first CORESET ID.

40. The base station of claim 39, wherein the first MAC-CE specifies at least two TCI states for the second CORESET ID.

41. The base station of claim 38, wherein the first MAC-CE includes an indicator bit that specifies whether a second TCI state of the one or more TCI states for the first CORESET ID is to be updated.

42. The base station of claim 38, wherein first MAC-CE includes an activation bit that specifies whether to activate or deactivate the one or more TCI states for the first CORESET ID and the one or more TCI states for the second CORESET ID.

43. The base station of claim 37, wherein the first CORESET ID is part of a first CORESET pool index associated with the first TRP, and the second CORESET ID is part of a second CORESET pool index associated with the second TRP.

44. The base station of claim 37, wherein the one or more TCI states for the first CORESET ID correspond to a first downlink control information (DCI) and the one or more TCI states for the second CORESET ID correspond to a second DCI.

45. The base station of claim 37, wherein the first MAC-CE indicates a serving cell that is used to update TCI states for CORESET IDs of other serving cells that are included in a serving cell list with the serving cell, based at least in part on TCI states for CORESET IDs that are indicated in the first MAC-CE.

46. The base station of claim 37, wherein the first MAC-CE indicates a single frequency network physical downlink control channel mode if the first MAC-CE specifies at least two TCI states for each CORESET ID.

47. The base station of claim 37, wherein the first MAC-CE indicates a non-single frequency network physical downlink control channel mode if the first MAC-CE specifies only one TCI state for each CORESET ID.

48. The base station of claim 37, wherein the first MAC-CE specifies the one or more TCI states for the first CORESET ID, and wherein the one or more processors are configured to transmit the second MAC-CE, wherein the second MAC-CE specifies the one or more TCI states for the second CORESET ID.

49.-52. (canceled)
